(19) United States
(12) Patent Application Publication
(10) Pub. No.: US 2026/0011504 A1
(43) Pub. Date: Jan. 8, 2026

(54) MULTILAYER CERAMIC ELECTRONIC COMPONENT

(71) Applicant: Murata Manufacturing Co., Ltd., Nagaokakyo-shi (JP)

(72) Inventor: Kota ZENZAI, Nagaokakyo-shi (JP)

(21) Appl. No.: 19/327,189

(22) Filed: Sep. 12, 2025

Related U.S. Application Data
(63) Continuation of application No. PCT/JP2024/010486, filed on Mar. 18, 2024.

(30) Foreign Application Priority Data
Mar. 30, 2023 (JP) 2023-056330

(51) Int. Cl. H01G 4/30; H01G 4/232

(52) U.S. Cl. CPC H01G 4/30; H01G 4/232

(57) ABSTRACT

A multilayer ceramic electronic component includes a laminate including an inner layer portion including dielectric layers and internal electrode layers, two main surfaces opposing each other in a lamination direction, and two end surfaces opposing each other in a length direction, two external electrodes connected to the internal electrode layers respectively at the two end surfaces and which cover the end surfaces and a portion of the two main surfaces continuous therefrom and opposing each other, and two spacers on one of the two main surfaces sandwiching the external electrodes between the main surface and the two spacers. One of the two surfaces of the spacers opposing each other in the lamination direction and not sandwiching the external electrode has an angle with respect to the main surface of the laminate on which the spacer is located that is about five degrees or less when viewed from the width direction.

### CROSS REFERENCE TO RELATED APPLICATIONS

This application claims the benefit of priority to Japanese Patent Application No. 2023-056330 filed on Mar. 30, 2023 and is a Continuation Application of PCT Application No. PCT/JP2024/010486 filed on Mar. 18, 2024. The entire contents of each application are hereby incorporated herein by reference.

### BACKGROUND OF THE INVENTION

### 1. Field of the Invention

The present invention relates to multilayer ceramic electronic components such as multilayer ceramic capacitors.

### 2. Description of the Related Art

Multilayer ceramic capacitors each include an inner layer portion in which dielectric layers and internal electrodes are alternately laminated. Then, dielectric layers defining and functioning as outer layer portions are provided at the top and bottom of the inner layer portion to form a rectangular parallelepiped multilayer body, and external electrodes are provided on both end surfaces in the longitudinal direction of the multilayer body to form a capacitor main body.

Furthermore, in order to reduce or prevent the occurrence of “acoustic noise”, multilayer ceramic capacitors are known that each include a spacer that covers a portion of the external electrode on a side of the capacitor main body to be mounted on a substrate (see, for example, Japanese Unexamined Patent Application, Publication No. 2015-216337).

However, depending on the shape of the spacers, it may be difficult to mount the multilayer ceramic capacitor on a circuit board, or when solder that is heated and melted during mounting spreads along the surface of the spacers and wets up high in the dimension in the height direction of the multilayer ceramic capacitor, the stretching vibration of the inner layer portion propagates to the circuit board, which may make it difficult to reduce or prevent the occurrence of acoustic noise.

Therefore, the development of multilayer ceramic capacitors that are each able to be reliably mounted on a circuit board and reduce or prevent the occurrence of acoustic noise has been demanded.

### SUMMARY OF THE INVENTION

Example embodiments of the present invention provide multilayer ceramic capacitors that are each able to be reliably mounted on a circuit board and reduce or prevent the occurrence of acoustic noise.

The inventor of example embodiments of the present invention has discovered that in a multilayer ceramic capacitor including spacers, when the second main surface of each of the spacers that are bonded to the land of the circuit board is positioned to define an angle of about 5 degrees or less when viewed from the width direction with respect to the main surface of the multilayer body on which the spacer is provided, the gap between the land of the circuit board and each of the spacers is reduced, such that the multilayer ceramic capacitor can be reliably mounted.

An example embodiment of the present invention provides a multilayer ceramic electronic component which includes a multilayer body including an inner portion in which dielectric layers and internal electrode layers are alternately laminated, two main surfaces opposed to each other in a lamination direction, two end surfaces opposed to each other in a length direction intersecting the lamination direction, and two lateral surfaces opposed to each other in a width direction intersecting the lamination direction and the length direction, two external electrodes each at one of the two end surfaces, each connected to the internal electrode layers, and each covering a corresponding one of the two end surfaces and portions of one of the two main surfaces extending from a corresponding one of the two end surfaces, and two spacers on one of the two main surfaces of the multilayer body, and each sandwiching a corresponding one of the two external electrodes with the one of the two main surfaces of the multilayer body, in which among two surfaces of each of the two spacers that are opposed to each other in the lamination direction, when a surface that sandwiches a corresponding one of the two external electrodes is defined as a first main surface and a surface that does not sandwich the corresponding one of the two external electrodes is defined as a second main surface, an angle of the second main surface of each of the two spacers with respect to the one of the two main surfaces of the multilayer body on which the two spacers are provided is about 5 degrees or less when viewed from the width direction.

According to example embodiments of the present invention, multilayer ceramic capacitors that are each able to be reliably mounted on a circuit board and reduce or prevent the occurrence of acoustic noise are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a diagram showing an external appearance of a multilayer ceramic capacitor 1 according to an example embodiment of the present invention.

FIG. 2 is a cross-sectional view of the multilayer ceramic capacitor 1 taken along the line II-II shown in FIG. 1.

FIG. 3 is a cross-sectional view of the multilayer ceramic capacitor 1 taken along the line III-III shown in FIG. 1.

FIGS. 4A to 4D are schematic diagrams of spacers having various shapes as viewed from the width direction W.

FIG. 5 is an enlarged cross-sectional view of a spacer 4 shown in FIG. 2.

FIG. 6 is a flowchart showing example of a manufacturing method of the multilayer ceramic capacitor 1 according to an example embodiment of the present invention.

FIGS. 7A to 7D are diagrams explaining a multilayer body manufacturing step S1, a base electrode layer formation step S2, and a first plated layer formation step S3.

FIGS. 8A to 8D are diagrams explaining a spacer placement step S4 and a second plated layer formation step S5.

FIG. 9 is a cross-sectional view showing the multilayer ceramic capacitor 1 without a second plated layer 32.

FIG. 10 is a cross-sectional view of the multilayer ceramic capacitor 1 provided with a reinforcing material 50 according to an example embodiment of the present invention.

FIGS. 11A to 11C are diagrams explaining a reinforcing material placement step S6.

### DETAILED DESCRIPTION OF THE EXAMPLE EMBODIMENTS

Example embodiments of the present invention will be described in detail with reference to the drawings.

In the following, a multilayer ceramic capacitor 1 will be described as an example embodiment of a multilayer ceramic electronic component according to the present invention, but the present invention is not limited thereto. Also, the drawings may be schematically simplified to explain the content of the present invention, and the ratio of dimensions of the components or between components shown may not necessarily match the ratio of their dimensions described in the specification. Also, components described in the specification may be omitted in the drawings, or the number of components may be reduced in the drawings.

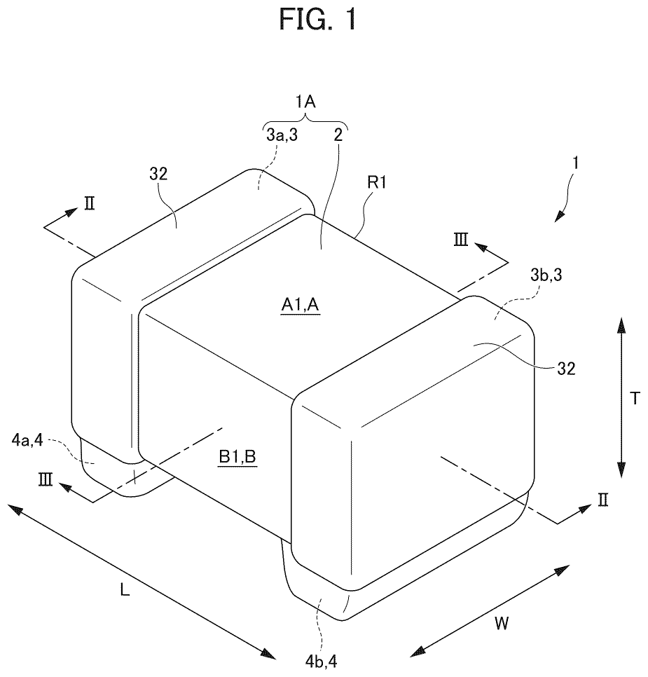

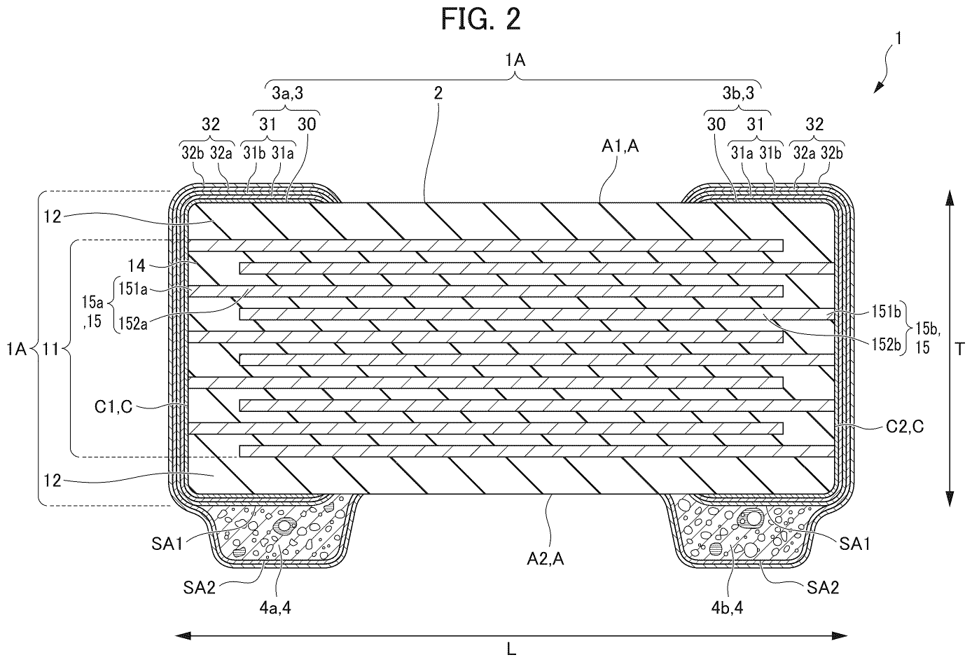

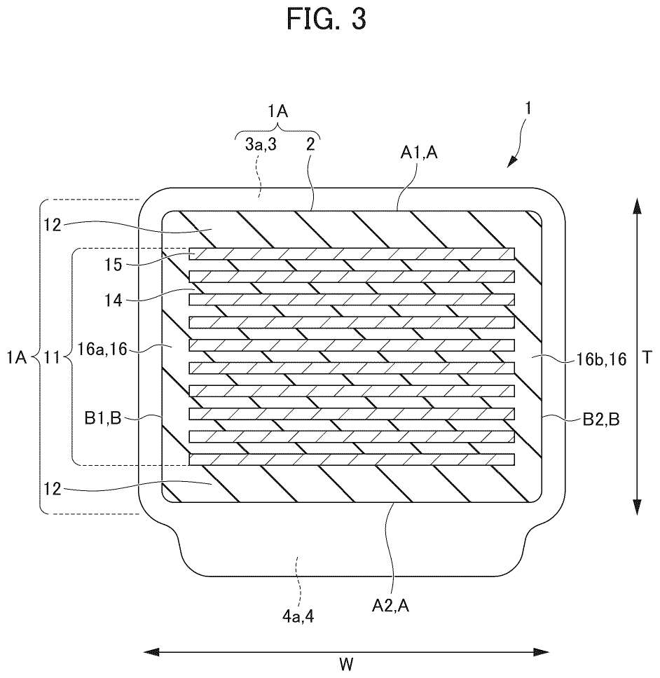

FIG. 1 is a schematic perspective view of a multilayer ceramic capacitor 1 according to an example embodiment of the present invention. FIG. 2 is a cross-sectional view taken along the line II-II in FIG. 1 of the multilayer ceramic capacitor 1 according to an example embodiment of the present invention. FIG. 3 is a cross-sectional view taken along the line III-III in FIG. 1 of the multilayer ceramic capacitor 1 according to an example embodiment of the present invention.

The multilayer ceramic capacitor 1 has a rectangular or substantially rectangular parallelepiped shape, and includes a capacitor main body 1A including a multilayer body 2 and a pair of external electrodes 3 provided at both ends of the multilayer body 2, and at least one spacer 4 attached to the capacitor main body 1A. The multilayer body 2 includes an inner layer portion 11 including dielectric layers 14 and internal electrode layers 15 laminated together.

In the following description, as terms representing the orientation of the multilayer ceramic capacitor 1, the direction in which the pair of external electrodes 3 are provided in the multilayer ceramic capacitor 1 is defined as the length direction L. The direction in which the dielectric layers 14 and the internal electrode layers 15 are stacked is defined as the lamination direction T. The direction intersecting both the length direction L and the lamination direction T is defined as the width direction W. In the example embodiments, the width direction W is orthogonal or substantially orthogonal to both the length direction L and the lamination direction T.

### Outer Surface of Multilayer Body 2

Among the six outer surfaces of the multilayer body 2, a pair of outer surfaces opposed to each other in the lamination direction T is defined as a first main surface A1 and a second main surface A2, a pair of outer surfaces opposed to each other in the width direction W is defined as a first lateral surface B1 and a second lateral surface B2, and a pair of outer surfaces opposed to each other in the length direction L is defined as a first end surface C1 and a second end surface C2. When there is no need to particularly distinguish between the first main surface A1 and the second main surface A2, they are collectively referred to as main surfaces A, when there is no need to particularly distinguish between the first lateral surface B1 and the second lateral surface B2, they are collectively referred to as lateral surfaces B, and when there is no need to particularly distinguish between the first end surface C1 and the second end surface C2, they are collectively referred to as end surfaces C.

The multilayer body 2 preferably has rounded ridge portions R1 including corner portions. The ridge portions R1 are portions where two surfaces of the multilayer body 2 intersect, i.e., where the main surface A and the lateral surface B, the main surface A and the end surface C, or the lateral surface B and the end surface C intersect.

### Multilayer Body 2

The multilayer body 2 includes an inner layer portion 11 that generates capacitance, outer layer portions 12 that sandwich the inner layer portion 11 in the lamination direction T, and side gap portions 16 that sandwich the inner layer portion 11 and the outer layer portions 12 in the width direction W.

### Inner Layer Portion 11

The inner layer portion 11 includes dielectric layers 14 and internal electrode layers 15 alternately laminated along the lamination direction T.

### Dielectric Layer 14

The dielectric layers 14 are each manufactured from a ceramic material. As the ceramic material, for example, a dielectric ceramic with BaTiO₃ as a main component is used.

### Internal Electrode Layer 15

The internal electrode layers 15 include a plurality of first internal electrode layers 15a and a plurality of second internal electrode layers 15b. The first internal electrode layers 15a and the second internal electrode layers 15b are alternately provided. The first internal electrode layers 15a each include a first counter portion 152a opposed to a corresponding one of the second internal electrode layers 15b, and a first extension portion 151a extending from the first counter portion 152a toward the first end surface C1. The end portion of the first extension portion 151a is exposed at the first end surface C1, and is electrically connected to the first external electrode 3a described later. The second internal electrode layers 15b each include a second counter portion 152b opposed to a corresponding one of the first internal electrode layers 15a, and a second extension portion 151b extending from the second counter portion 152b toward the second end surface C2. The end portion of the second extension portion 151b is electrically connected to the second external electrode 3b described later. Electric charge is accumulated in the first counter portion 152a of each of the first internal electrode layers 15a and the second counter portion 152b of each of the second internal electrode layers 15b.

The internal electrode layers 15 are preferably made of a metal material such as, for example, nickel (Ni), copper (Cu), silver (Ag), palladium (Pd), silver-palladium (Ag—Pd) alloy, or gold (Au).

### Outer Layer Portion 12

The outer layer portion 12 can each be made of the same material as the dielectric layers 14 of the inner layer portion 11.

### Side Gap Portion 16

The side gap portions 16 sandwich the inner layer portion 11 and the outer layer portion 12 in the width direction W. The side gap portions 16 include a first side gap portion 16a that defines and functions as the first lateral surface B1 of the multilayer ceramic capacitor 1, and a second side gap portion 16b that defines and functions as the second lateral surface B2 of the multilayer ceramic capacitor 1. The side gap portions 16 can be made of the same material as the dielectric layer 14.

### External Electrode 3

The external electrodes 3 include a first external electrode 3a provided on the first end surface C1, and a second external electrode 3b provided on the second end surface C2. The external electrodes 3 cover not only the end surface C, but also portions of the main surface A and portions of the lateral surface B extending with the end surface C.

As described above, the end portion of the first extension portion 151a of each of the first internal electrode layers 15a is exposed at the first end surface C1, and is electrically connected to the first external electrode 3a. Furthermore, the end portion of the second extension portion 151b of each of the second internal electrode layers 15b is exposed at the second end surface C2, and is electrically connected to the second external electrode 3b. This provides a configuration in which a plurality of capacitor elements are electrically connected in parallel between the first external electrode 3a and the second external electrode 3b.

The external electrodes 3 each include, for example, a base electrode layer 30 and a first plated layer 31. However, it is not necessarily required that the external electrodes 3 include such a layered configuration.

The base electrode layer 30 is formed, for example, by applying and firing an electrically conductive paste including copper (Cu). The base electrode layer 30 of the present example embodiment may also include glass and ceramic material, for example. The configuration of the base electrode layer 30 is not limited thereto.

The first plated layer 31 includes, for example, a first nickel (Ni) plated layer 31a provided on the surface of the base electrode layer 30, and a first tin (Sn) plated layer 31b provided on the surface of the first nickel (Ni) plated layer 31a. The configuration of the first plated layer 31 is not limited thereto.

### Spacer 4

The spacer 4 includes a pair of a first spacer 4a and a second spacer 4b. The first spacer 4a and the second spacer 4b are provided on the second main surface A2, which is a substrate mounting surface of the capacitor main body 1A. The first spacer 4a is provided adjacent to the end surface C1 in the length direction L, and the second spacer 4b is provided adjacent to the end surface C2 in the length direction L. When the substrate mounting surface of the capacitor main body 1A is the first lateral surface B1, the first spacer 4a and the second spacer 4b are provided on the first lateral surface B1, which is a substrate mounting surface of the capacitor main body 1A. The first spacer 4a is provided adjacent to the end surface C1 in the length direction L, and the second spacer 4b is provided adjacent to the end surface C2 in the length direction L.

The spacer 4 is provided on the external electrode 3 of the capacitor main body 1A and on the surface of the second main surface A2 of the multilayer body 2 where the external electrode 3 is not provided. When the substrate mounting surface of the capacitor main body 1A is the first lateral surface B1, the spacer 4 is provided on the external electrode 3 of the capacitor main body 1A and on the surface of the first lateral surface B1 of the multilayer body 2 where the external electrode 3 is not provided.

The spacer 4 has a rectangular or substantially rectangular parallelepiped shape. Among the two surfaces opposed to each other in the lamination direction T on the surface of the spacer, when the surface that sandwiches the external electrode 3 between itself and the second main surface A2 of the multilayer body 2 is defined as the first main surface SA1, and the surface that does not sandwich the external electrode 3 is defined as the second main surface SA2, the angle of the second main surface SA2 of the spacer 4 with respect to the second main surface A2 of the multilayer body 2 is, for example, about 5 degrees or less when viewed from the width direction W. This allows the multilayer ceramic capacitor 1 to be provided while the second main surface SA2 of the spacer 4 is parallel or substantially parallel to the circuit board, such that when bonding using solder is performed, no gap occurs between the spacer 4 and the land provided on the circuit board, thus enabling reliable bonding. In addition, it is possible to reduce the difference between the two spacers 4 in regards to the amount of solder that enters between the two spacers 4 and the second main surface A2 of the multilayer body 2, such that it is possible to reduce or prevent the variation in the relative position of the two spacers 4 caused by solder shrinkage, and improve mountability. In a case where the substrate mounting surface of the capacitor main body 1A is the first lateral surface B1, among the two surfaces opposed to each other in the width direction W on the surface of the rectangular or substantially rectangular parallelepiped-shaped spacer 4, when the surface that sandwiches the external electrode 3 between itself and the first lateral surface B1 of the multilayer body 2 is defined as the first lateral surface SB1, and the surface that does not sandwich the external electrode 3 is defined as the second lateral surface SB2, the angle of the second lateral surface SB2 of the spacer 4 with respect to the first lateral surface B1 of the multilayer body 2 is, for example, about 5 degrees or less when viewed from the lamination direction T.

As a method for measuring the angle of the second main surface SA2 of the spacer 4 with respect to the second main surface A2 of the multilayer body 2, for example, the spacer 4 is polished perpendicularly or substantially perpendicularly in the width direction W to the middle in the width direction W, and the polished surface is photographed at a total magnification of about 10 times with a microscope (BX-51) connected to a digital camera for microscopes (DP22, manufactured by Olympus). In the photographed image, the angle between the line connecting both ends of the second main surface A2 of the multilayer body 2 and the line connecting both ends of the second main surface SA2 of the spacer 4 can be measured. When both ends are rounded, the portions that are not rounded are taken as both ends.

When the solder that is heated and melted during mounting travels along the surface of the spacer 4 and spreads high on the surface of the external electrode 3 along the end surface C in a direction perpendicular or substantially perpendicular to the mounting surface of the multilayer ceramic capacitor 1, the stretching vibration of the inner layer portion 11 propagates to the circuit board, making it difficult to reduce or prevent the occurrence of acoustic noise in some cases. Therefore, when the spacer 4 is viewed from the width direction W, it is preferable that the length W1 in the length direction L of the first main surface SA1 of the spacer 4 is, for example, about 95% or less, or about 105% or more of the length W3 in the length direction L of the second main surface SA2 of the spacer 4. This can reduce or prevent the melted solder from traveling along the surface of the spacer 4 and spreading.

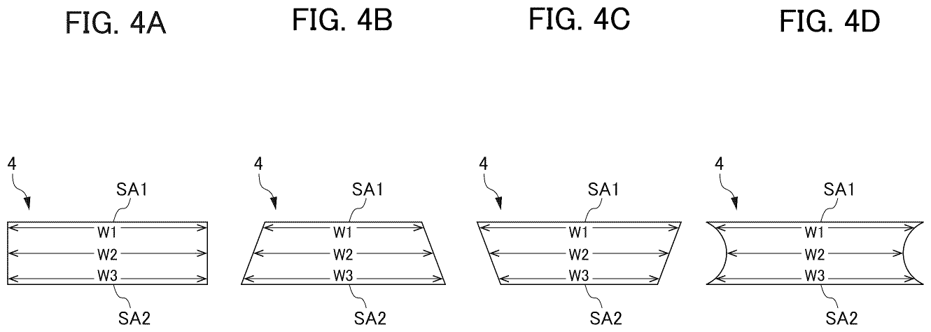

In addition, when the spacer 4 is viewed from the width direction W, it is preferable that the length W2 in the length direction L at the middle portion in the lamination direction T is shorter than the length W1 in the length direction L of the first main surface SA1 and the length W3 in the length direction L of the second main surface SA2. For example, as shown in the schematic diagram of FIGS. 4A to 4D, when the shape can be expressed by the relational expression W1<W2<W3 (FIG. 4B), the shape can be expressed as W1>W2>W3 (FIG. 4C), or the shape can be expressed as W1>W2 and W2<W3 (FIG. 4D), it is possible to reduce or prevent the melted solder from traveling along the surface of the spacer 4 and spreading. In addition, when the spacer has such a shape, the bonding area with the reinforcing material described later also increases, such that the bonding strength between the spacer and the multilayer ceramic capacitor is improved. The same applies when the substrate mounting surface of the capacitor main body 1A is the first lateral surface B1.

As a method for measuring W1, W2, and W3, for example, the spacer 4 is polished perpendicularly or substantially perpendicularly in the width direction W to the middle in the width direction W, and the polished surface is photographed at a total magnification of about 10 times with a microscope (BX-51) connected to a digital camera for microscopes (DP22, manufactured by Olympus). The length of each portion is measured from the photographed image.

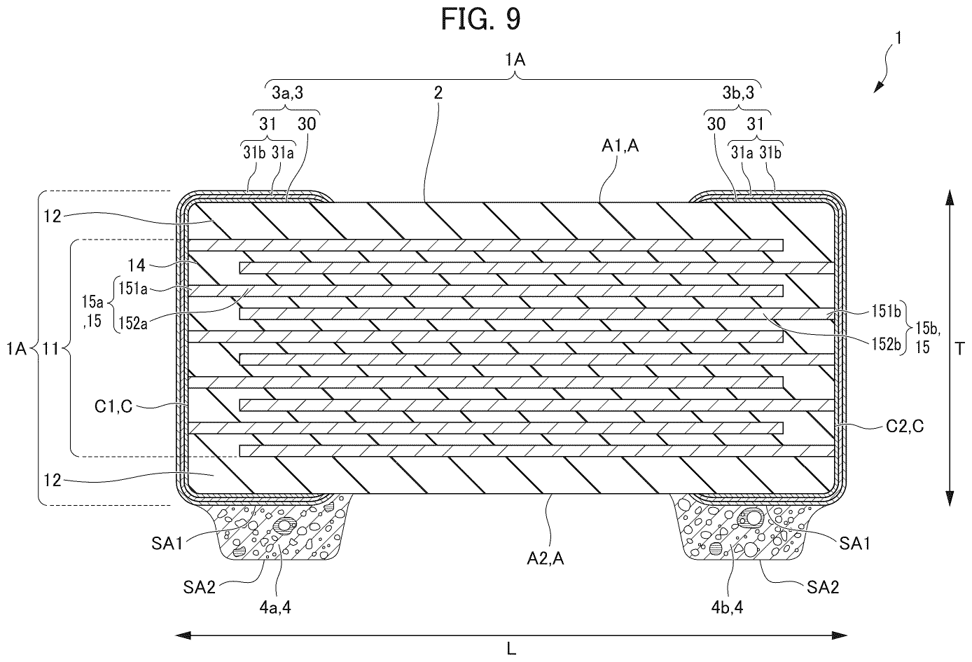

The second plated layer 32 covers the spacer 4 and the external electrode 3, but the present invention is not limited thereto, and the second plated layer 32 may not necessarily be provided on the spacer 4 and the external electrode 3 (FIG. 9). When the second plated layer 32 covers the spacer 4 and the external electrode 3, the second plated layer 32 includes, for example, a second nickel (Ni) plated layer 32a and a second tin (Sn) plated layer 32b provided on the surface of the second nickel (Ni) plated layer 32a. The second plated layer 32 is provided on the outer surface of the first tin (Sn) plated layer 31b of the first plated layer 31 in portions where the spacer 4 is not provided, and is provided on the outer surface of the spacer 4 in portions where the spacer 4 is provided. The configuration of the second plated layer 32 is not limited thereto. By providing the second plated layer 32, the bonding strength between the spacer 4 and the capacitor main body 1A is improved.

In an example embodiment, the external electrode 3 includes the base electrode layer 30 and the first plated layer 31 that covers the base electrode layer 30, and the spacer 4 is provided on the surface of the first plated layer 31. However, the first plated layer 31 is not necessarily required. For example, the spacer 4 may be provided on the surface of the base electrode layer 30, and the second plated layer 32 may be provided to cover the spacer 4 and the base electrode layer 30. By providing the second plated layer 32, the bonding strength between the spacer 4 and the base electrode layer 30 is improved, and the mechanical strength of the spacer 4 is improved by the second plated layer 32 entering the voids P exposed on the surface of the spacer 4.

The spacer 4 includes, for example, as metal powder, either copper (Cu) or nickel (Ni), and tin (Sn). The copper (Cu) and nickel (Ni) may be coated with silver (Ag), for example. The intermetallic compound formed by adding either copper (Cu) or nickel (Ni), and tin (Sn) does not undergo thermal deformation when the multilayer ceramic capacitor 1 is mounted on a circuit board, even during soldering, and can reliably maintain the shape of the spacer 4. In particular, an intermetallic compound formed by adding tin (Sn) to an alloy of copper (Cu) and nickel (Ni) is preferable as a component for the spacer 4.

The metal region MP defined by the metal powder may include phenol resin, for example. The phenol resin coats the intermetallic compound particles and is scattered to fill the gaps between the particles. The phenol resin may not necessarily completely coat the intermetallic compound particles. In addition, by using phenol resin, the amount of gas generated during the heat treatment when forming the spacer 4 can be reduced, thus reducing the voids P in the spacer 4. The phenol resin may be exposed on the surface of the spacer 4 and cover at least a portion of the surface of the spacer 4. By covering the surface of the spacer 4 with phenol resin, the smoothness of the surface of the spacer 4 is improved, and the mechanical strength of the spacer 4 can be increased.

Examples of the phenol resin include novolac-type phenol resins such as phenol novolac resin, phenol aralkyl resin, cresol novolac resin, tert-butylphenol novolac resin, and nonylphenol novolac resin, resol-type phenol resin, and polyoxystyrenes such as polyparaoxystyrene.

The area ratio of phenol resin is, for example, preferably about 1% or more and about 20% or less, and more preferably about 5% or more and about 15% or less, in the LT cross-section perpendicular or substantially perpendicular to the width direction W of the spacer 4. When it is less than about 18, the effect of the phenol resin cannot be sufficiently provided, and when it exceeds about 20%, there is a risk that the bonding strength of the spacer to the external electrode will decrease.

As a method for determining the area ratio (%) of phenol resin, for example, the spacer 4 is polished in the width direction W to the middle position in the width direction W, and the polished surface is magnified about 50 times with a microscope (BX-51) and photographed with a digital camera for microscopes (DP22 manufactured by Olympus). The obtained image is binarized to separate the metal region MP and the resin region RP, and the area ratio (%) of phenol resin can be calculated by the formula: (area ratio (%) of phenol resin)=(area of resin region RP)/(area of metal region MP+area of metal powder MF+area of resin region RP+area of void P)×100, from the respective areas of the metal region MP, metal powder MF, resin region RP, and void P.

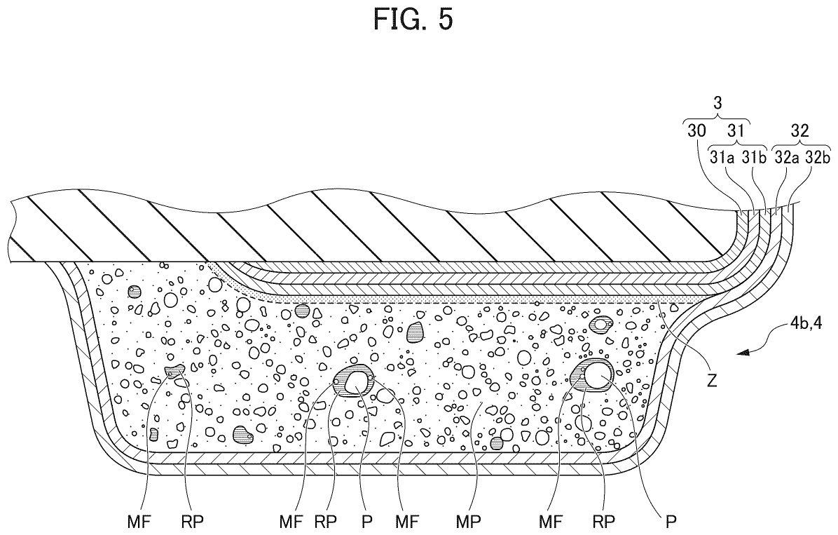

As shown in FIG. 5, the resin region RP defined by the phenol resin may include metal powder MF. The shrinkage of the phenol resin is reduced or prevented by the metal powder MF, and the shrinkage stress caused by the phenol resin can be reduced.

The spacer 4 preferably has a void ratio of, for example, about 20% or less in the region Z within about 5 μm from the interface with the external electrode 3. By keeping the void ratio low, the bonding area of the spacer 4 that bonds with the external electrode 3 increases, thus improving the bonding strength with the external electrode 3.

As a method for determining the void ratio (%), for example, the spacer 4 is polished in the width direction W to the middle position in the width direction W, and the polished surface is magnified about 50 times with a microscope (BX-51) and photographed with a digital camera for microscopes (DP22 manufactured by Olympus). The obtained image is binarized to separate the metal region MP and the void P portions, and the void ratio (%) can be calculated by the formula: void ratio (%)=(area of void P)/(area of metal region MP+ area of metal powder MF+ area of resin region RP+ area of void P)×100, from the respective areas of the metal region MP, metal powder MF, resin region RP, and void P.

The maximum diameter of the voids P provided inside the spacer 4 is, for example, preferably about ½ or less of the maximum dimension in the thickness of the spacer 4 in the lamination direction T. If the maximum diameter of the voids P exceeds about ½ of the maximum dimension in the thickness of the spacer 4 in the lamination direction T, cracks are likely to occur with the voids P as starting points, reducing the strength of the spacer 4. When the substrate mounting surface of the capacitor main body 1A is the first lateral surface B1, the maximum diameter of the voids P provided inside the spacer 4 is, for example, preferably about ½ or less of the maximum dimension in the thickness of the spacer 4 in the width direction W.

In the above, a configuration including intermetallic compounds and phenol resin is shown as an example of the material of the spacer 4, but the present invention is not limited thereto, and may include different types of metal components, or may include, for example, resins such as epoxy resin and rosin, or glass components in addition to phenol resin. Also, it may not include resin.

In a plan view from the lamination direction T, when the spacer 4 is smaller than the external electrode 3, it is preferable to provide a direction identification mark on at least a portion of the spacer 4. The direction identification mark indicates the direction in which opposing the second main surface A2 where the spacer 4 is provided toward the wiring board when mounting the multilayer ceramic capacitor 1 on the wiring board, and can include a mark such as coloring the spacer 4 with a color different from the external electrode 3, printing marks such as a QR code (registered trademark) for identifying direction, or providing a recessed portion at a portion of the multilayer body 2. As a coloring mark, the phenol resin included in the spacer 4 may be exposed on the surface of the spacer 4 to show a color different from the external electrode 3. Even when the spacer 4 is larger than the external electrode 3, a direction identification mark may be provided.

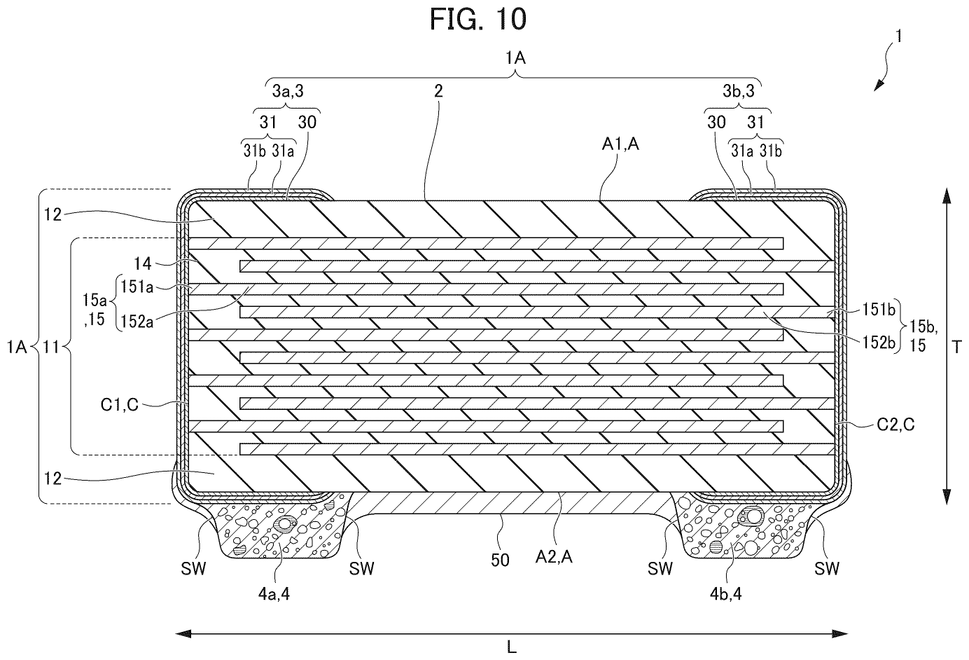

As shown in FIG. 10, between the first spacer 4a and the second spacer 4b, a reinforcing material 50 can be provided so as to cover at least a portion of at least one of the first spacer 4a and the second spacer 4b, and at least a portion of the second main surface A2 or the first lateral surface B1 of the multilayer body 2. By providing the reinforcing material 50, it is possible to improve the bonding strength between the spacer 4 and the external electrode 3, and between the spacer 4 and the multilayer body 2.

The reinforcing material 50 can be provided continuously between the first spacer 4a and the second spacer 4b, but it is not necessary to provide the reinforcing material 50 continuously. For example, the reinforcing material 50 may be provided separately as one that covers a portion of the first spacer 4a and a portion of the second main surface A2 or the first lateral surface B1 of the multilayer body 2, and another that covers a portion of the second spacer 4b and a portion of the second main surface A2 or the first lateral surface B1 of the multilayer body 2.

The reinforcing material 50 can be made of insulating resin, for example. The surface of the insulating resin may be covered with an insulating water repellent treatment agent, for example. By forming the reinforcing material with insulating resin, the deflection strength is improved, and by further covering with an insulating water repellent treatment agent, moisture resistance is improved. The insulating resin may include, for example, ceramics, glass, and the like. The reinforcing material may be made only of the water repellent treatment agent.

As the material of the reinforcing material 50, for example, epoxy resin can be used as a main component, and phenol resin can be combined as a curing agent. As other curing agents, for example, acid anhydride-based, amine-based, and ester-based curing agents can be used. A curing accelerator may be further added to the epoxy resin.

The reinforcing material 50 can be provided so as to cover the lateral peripheral surface SW of the spacer 4. In this case, it is preferable that the reinforcing material 50 covers the lateral peripheral surface SW of the spacer 4 at a height of, for example, about 5% or more of the length of the spacer 4 in the lamination direction T, while covering the second main surface A2 or the first lateral surface B1 of the multilayer body 2. By covering with the reinforcing material 50 in this manner, the mechanical strength is improved, and in particular, impact resistance when an impact is applied to the multilayer ceramic capacitor 1 can be improved.

### Method of Manufacturing Multilayer Ceramic Capacitor 1

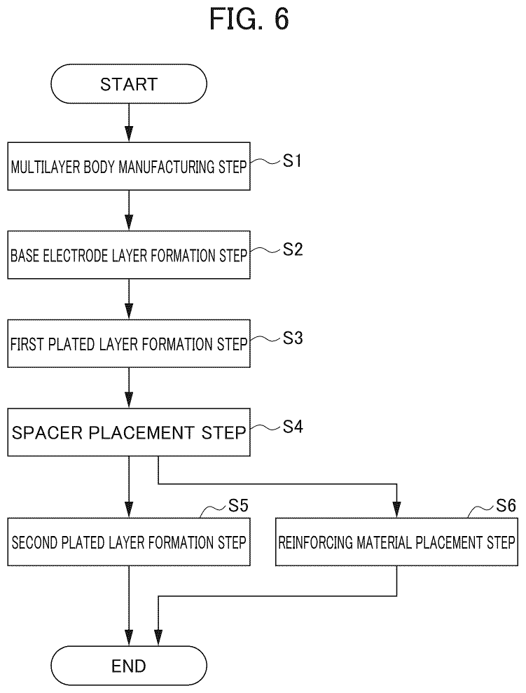

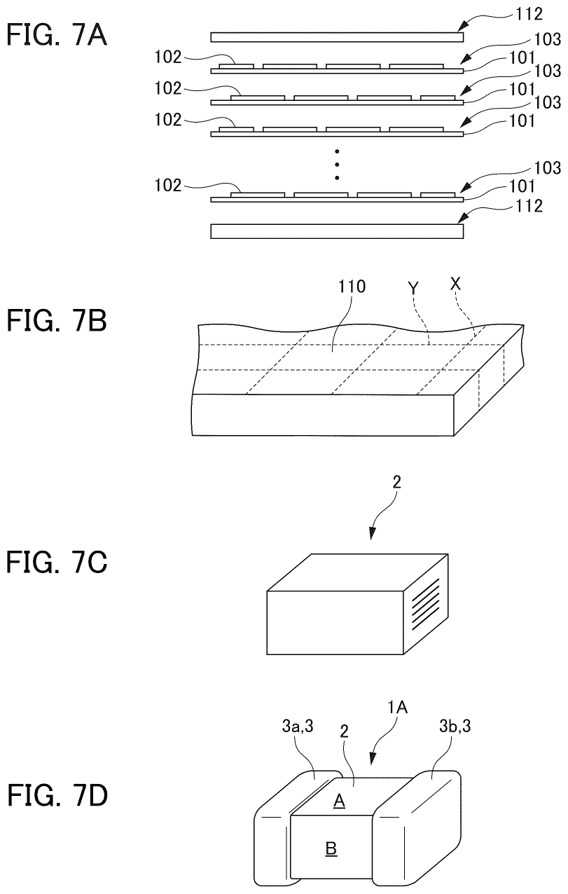

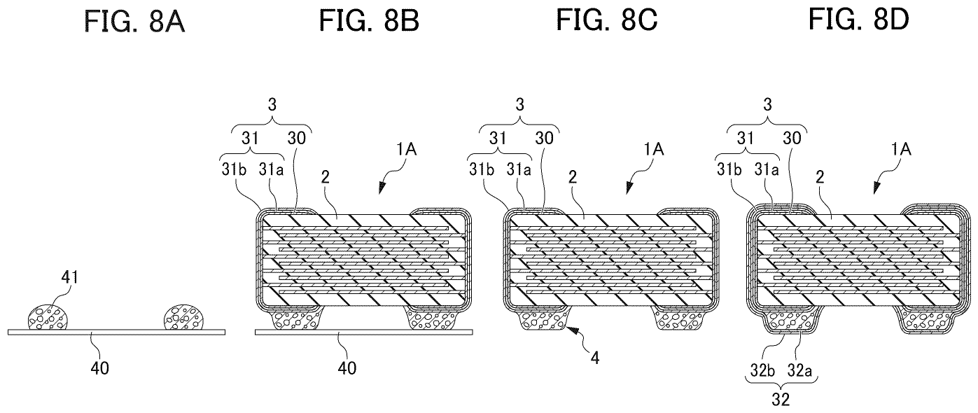

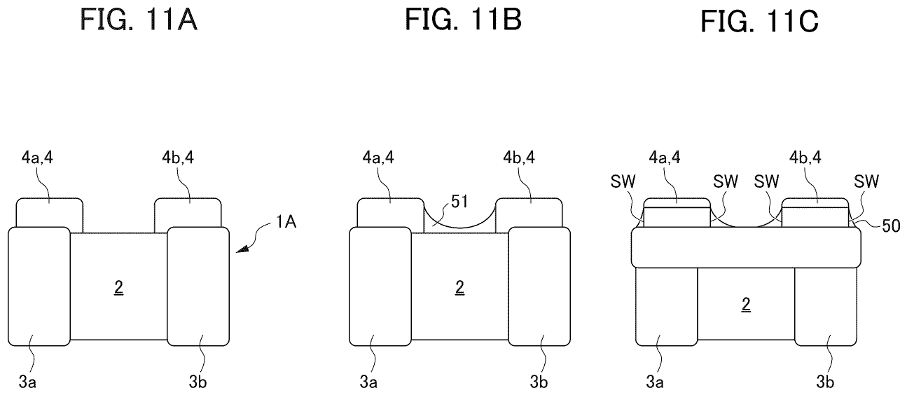

FIG. 6 is a flowchart explaining an example of a method of manufacturing the multilayer ceramic capacitor 1. The example of the method of manufacturing the multilayer ceramic capacitor 1 includes a multilayer body manufacturing step S1, a base electrode layer formation step S2, a first plated layer formation step S3, a spacer placement step S4, and a second plated layer formation step S5. Further, the multilayer ceramic capacitor 1 can include the reinforcing material 50 by subjecting to a reinforcing material placement step S6 after the spacer placement step S4. FIGS. 7A to 7D are diagrams explaining the multilayer body manufacturing step S1, the base electrode layer formation step S2, and the first plated layer formation step S3. FIGS. 8A to 8C are diagram explaining the spacer placement step S4 and the second plated layer formation step S5. FIGS. 11A to 11C are diagrams explaining the reinforcing material placement step S6.

### Multilayer Body Manufacturing Step S1

A ceramic slurry including ceramic powder, binder, and solvent is formed into a sheet on the surface of a carrier film using, for example, a die coater, gravure coater, micro gravure coater, etc., to create a multilayer ceramic green sheet 101 that defines and functions as the dielectric layer 14. Next, an electrically conductive paste is printed in a strip pattern on the multilayer ceramic green sheet 101 by, for example, screen printing, inkjet printing, gravure printing, etc., and an electrically conductive pattern 102 that defines and functions as the internal electrode layer 15 is printed on the surface of the multilayer ceramic green sheet 101 to create a material sheet 103.

Next, as shown in FIG. 7A, a plurality of material sheets 103 are stacked such that the electrically conductive patterns 102 face in the same direction and the electrically conductive patterns 102 are offset from each other by, for example, about half a pitch in the length direction between adjacent material sheets 103. Furthermore, ceramic green sheets 112 for outer layer portions, which define and function as the outer layer portions 12, are stacked on both sides of the plurality of stacked material sheets 103.

The plurality of stacked material sheets 103 and the ceramic green sheets 112 for outer layer portions are pressed together using, for example, a hydrostatic press or the like to create a mother block 110 as shown in FIG. 7B.

Next, the mother block 110 is cut along cutting lines X and cutting lines Y that intersect the cutting lines X as shown in FIG. 7B to manufacture a plurality of multilayer bodies to be fired 2 as shown in FIG. 7C.

### Base Electrode Layer Formation Step S2

Next, a base electrode layer 30 is formed by applying and firing an electrically conductive paste including, for example, copper (Cu) to the end surfaces C of the multilayer body 2. The base electrode layer 30 extends not only on both end surfaces C of the multilayer body 2, but also to the main surfaces A and lateral surfaces B, so as to cover portions of the main surfaces A adjacent to the end surfaces C. However, the base electrode layer is not limited thereto, and may include other metals or other components, and two base electrode layers may be provided.

### First Plated Layer Formation Step S3

Next, for example, a first nickel (Ni) plated layer 31a is formed on the surface of the base electrode layer 30, and a first tin (Sn) plated layer 31b is provided on the surface of the first nickel (Ni) plated layer 31a to manufacture the capacitor main body 1A shown in FIG. 7D.

### Spacer Placement Step S4

Spacer manufacturing pastes 41 for manufacturing spacers are prepared. The spacer manufacturing pastes 41 include, for example, metals such as copper (Cu), nickel (Ni), tin (Sn) or silver (Ag), phenol resin, solvent, or additives.

Examples of the phenol resin include novolac-type phenol resins such as phenol novolac resin, phenol aralkyl resin, cresol novolac resin, tert-butylphenol novolac resin, or nonylphenol novolac resin, resol-type phenol resin, or polyoxystyrenes such as polyparaoxystyrene.

For forming the spacers 4, a holding substrate 40 as shown in FIGS. 8A to 8C is used. The spacer manufacturing pastes 41 are provided on the holding substrate 40 by, for example, a screen printing method or dispensing method.

Next, as shown in FIG. 8B, the capacitor main body 1A is mounted on the upper surface of the holding substrate 40 in a posture where the second main surface A2 is opposed to the holding substrate 40. At this time, the external electrodes 3 of the capacitor main body 1A are aligned with the spacer manufacturing pastes 41, and the spacer manufacturing pastes 41 adhere to the capacitor main body 1A.

In this state, a heating step is performed. When at least a portion of the metal in the pastes forms an intermetallic compound to form a metal region MP, a portion of the phenol resin is incorporated into the metal region MP, while a portion thereof is discharged from the metal region MP, and the metal region MP is cured, such that spacers 4 bonded to the capacitor main body 1A are formed.

Thereafter, the capacitor main body 1A together with the spacers 4 is separated from the holding substrate 40, resulting in the state shown in FIG. 8C. The manufacturing method is not limited thereto, and the spacer manufacturing paste may be directly provided in a desired shape on the surface of the capacitor main body 1A, followed by heat treatment to form the spacer.

In order to adjust the spacers 4 to a predetermined shape, for example, the following method can be used.

In a case of a shape indicated by the relational expression W1<W2<W3, after printing the spacer manufacturing paste on the unfired multilayer body 2 by, for example, screen printing or the like, a smooth plate-shaped jig is pressed against the printed surface. The height of the jig is adjusted to increase the pressing amount against the spacer manufacturing paste, and then heat treatment is performed. In a case of a shape indicated by the relational expression W1>W2>W3, after printing the spacer manufacturing paste on the unfired multilayer body 2 by, for example, screen printing or the like, a smooth plate-shaped jig is pressed against the printed surface. The height of the jig is adjusted to reduce the pressing amount against the spacer manufacturing paste, and then heat treatment is performed. In a case of a shape indicated by the relational expressions W1>W2 and W2<W3, after printing the spacer manufacturing paste on the unfired multilayer body 2 by, for example, screen printing or the like, a smooth plate-shaped jig is pressed against the spacer manufacturing paste while adjusting the height, and then a heat treatment is performed in a state where the jig is moved in a direction away from the spacer manufacturing paste to an extent that it does not separate from the spacer manufacturing paste.

In the above, a configuration including intermetallic compounds and phenol resin is shown as an example of the material of the spacer 4, but the present invention is not limited thereto, and, for example, may include different types of metal components, or may include resins such as epoxy resin and rosin, or glass components in addition to phenol resin. Also, it may be formed without including resin.

### Second Plated Layer Formation Step S5

Next, for example, a second nickel (Ni) plated layer 32a may be formed on the portion where the first tin (Sn) plated layer 31b is exposed in the capacitor main body 1A, and on the surface of the spacer 4, and further the second tin (Sn) plated layer 32b may be formed on the outer periphery of the second nickel (Ni) plated layer 32a.

### Reinforcing Material Placement Step S6

FIGS. 11A to 11C are diagrams explaining the reinforcing material placement step S6. After the spacer placement step S4, the surface of the capacitor main body 1A on which the spacers 4 are provided is cleaned with a solvent. As shown in FIG. 11A, after the cleaning is completed, the capacitor main body 1A with the spacers 4 is aligned so that the spacers 4 face upward.

Next, as shown in FIG. 11B, an insulating resin layer defining and functioning as the middle portion 51 of the reinforcing material 50 is formed between the first spacer 4a and the second spacer 4b on the capacitor main body 1A with the spacers 4, using, for example, a dispenser or squeegee printing. The amount of wet spreading onto the lateral surface of the spacers 4 can be adjusted by changing the amount of insulating resin.

In order to allow the insulating resin to penetrate into the interface between the spacers 4 and the multilayer body 2, it is possible to perform vacuum drawing after placing the insulating resin. The amount of penetration can be controlled by changing the time and pressure of the vacuum drawing.

Next, as shown in FIG. 11C, the insulating resin may be applied to cover the outer periphery of the capacitor main body 1A and the outer periphery of the spacers 4. Then, by heating the applied insulating resin at, for example, about 100° C. to about 200° C. for about 20 minutes to about 80 minutes, the insulating resin is cured such that a covered portion by the reinforcing material 50 is formed on the outer periphery of the capacitor main body 1A and the lateral peripheral surfaces SW of the spacers 4. The multilayer ceramic capacitor 1 is manufactured through the above steps.

In the above-described example embodiments, the reinforcing material 50 directly covers the surfaces of the spacers 4, but the present invention is not necessarily limited thereto. For example, the second plated layer 32 may be provided on the surfaces of the spacers 4, and the reinforcing material 50 may cover the lateral peripheral surfaces SW of the spacers 4 on the surface of the second plated layer 32.

Although example embodiments of the present invention have been described above, the present invention is not limited to the example embodiments, and can be implemented in various configurations without departing from the scope of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a multilayer body including an inner layer portion including dielectric layers and internal electrode layers alternately laminated, two main surfaces opposed to each other in a lamination direction, two end surfaces opposed to each other in a length direction intersecting the lamination direction, and two lateral surfaces opposed to each other in a width direction intersecting the lamination direction and the length direction;
two external electrodes each at one of the two end surfaces, each connected to the internal electrode layers, and each covering a corresponding one of the two end surfaces and portions of one of the two main surfaces extending from a corresponding one of the two end surfaces; and
two spacers on one of the two main surfaces of the multilayer body, and each sandwiching a corresponding one of the two external electrodes with the one of the two main surfaces of the multilayer body; wherein
among two surfaces of each of the two spacers opposed to each other in the lamination direction, when a surface that sandwiches a corresponding one of the two external electrodes is defined as a first main surface and a surface that does not sandwich the corresponding one of the two external electrodes is defined as a second main surface, an angle of the second main surface of each of the two spacers with respect to the one of the two main surfaces of the multilayer body on which the two spacers are provided is about 5 degrees or less when viewed from the width direction.

2. The multilayer ceramic electronic component according to claim 1, wherein when each of the two spacers is viewed from the width direction, a length of the first main surface in the length direction is about 95% or less or about 1058 or more of a length of the second main surface in the length direction.

3. The multilayer ceramic electronic component according to claim 1, wherein, when each of the two spacers is viewed from the width direction, a length in the length direction of a middle portion in the lamination direction is shorter than a length of the first main surface in the length direction and a length of the second main surface in the length direction.

4. The multilayer ceramic electronic component according to claim 1, wherein each of the two spacers includes a resin.

5. The multilayer ceramic electronic component according to claim 1, wherein each of the two spacers includes copper and glass.

6. The multilayer ceramic electronic component according to claim 1, wherein each of the two spacers includes phenol resin.

7. The multilayer ceramic electronic component according to claim 1, wherein each of the two spacers includes epoxy resin.

8. The multilayer ceramic electronic component according to claim 1, wherein each of the two spacers includes rosin.

9. The multilayer ceramic electronic component according to claim 1, wherein a reinforcing material is provided between the two spacers to cover at least a portion of the two spacers and at least a portion of the two main surfaces of the multilayer body.

10. The multilayer ceramic electronic component according to claim 9, wherein the reinforcing material covers a lateral peripheral surface of the two spacers.

11. A multilayer ceramic electronic component comprising:
a multilayer body including an inner layer portion including dielectric layers and internal electrode layers alternately laminated, two main surfaces opposed to each other in a lamination direction, two end surfaces opposed to each other in a length direction intersecting the lamination direction, and two lateral surfaces opposed to each other in a width direction intersecting the lamination direction and the length direction;
two external electrodes each at one of the two end surfaces, each connected to the internal electrode layers, and each covering a corresponding one of the two end surfaces and portions of one of the two lateral surfaces extending from a corresponding one of the two end surfaces; and
two spacers on one of the two main surfaces of the multilayer body, and each sandwiching a corresponding one of the two external electrodes with the one of the two lateral surfaces of the multilayer body; wherein
among two surfaces of each of the two spacers opposed to each other in the width direction, when a surface that sandwiches a corresponding one of the two external electrodes is defined as a first lateral surface and a surface that does not sandwich the corresponding one of the two external electrodes is defined as a second lateral surface, an angle of the second lateral surface of each of the two spacers with respect to the one of the two lateral surfaces of the multilayer body on which the two spacers are provided is about 5 degrees or less when viewed from the lamination direction.

12. The multilayer ceramic electronic component according to claim 11, wherein, when each of the two spacers is viewed from the lamination direction, a length of the first lateral surface in the length direction is about 95% or less or about 105% or more of a length of the second lateral surface in the length direction.

13. The multilayer ceramic electronic component according to claim 11, wherein, when each of the two spacers is viewed from the lamination direction, a length in the length direction of a middle portion in the width direction is shorter than a length of the first lateral surface in the length direction and a length of the second lateral surface in the length direction.

14. The multilayer ceramic electronic component according to claim 11, wherein each of the two spacers includes a resin.

15. The multilayer ceramic electronic component according to claim 11, wherein each of the two spacers includes copper and glass.

16. The multilayer ceramic electronic component according to claim 11, wherein each of the two spacers includes phenol resin.

17. The multilayer ceramic electronic component according to claim 11, wherein each of the two spacers includes epoxy resin.

18. The multilayer ceramic electronic component according to claim 11, wherein each of the two spacers includes rosin.

19. The multilayer ceramic electronic component according to claim 11, wherein a reinforcing material is provided between the two spacers to cover at least a portion of the two spacers and at least a portion of the two lateral surfaces of the multilayer body.

20. The multilayer ceramic electronic component according to claim 19, wherein the reinforcing material covers a lateral peripheral surface of the two spacers.
